(19) United States
(12) Patent Application Publication
(10) Pub. No.: US 2009/0026857 A1
(43) Pub. Date: Jan. 29, 2009

(54) Electric Motor

(76) Inventor: Christian Lavall, Aichi (JP)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/092,373

(22) PCT Filed: Oct. 6, 2006
(86) PCT No.: PCT/EP06/67139

§ 371 Date: Sep. 18, 2008

(30) Foreign Application Priority Data
Nov. 2, 2005 (DE) 10 2005 052 363.

(51) Int. Cl. H02K 9/00

(52) U.S. Cl. 310/58

(57) ABSTRACT

The electric motor has a rotor (1), at least two magnet segments (2, 2′) and a housing (3). A collar (6) consisting of plastic is arranged around the housing (3) and has at least one helical projection (6′) on its outer side. An outer cover (7) in the form of a cup is arranged around the collar (6), the at least one helical projection (6′) bearing against the inner side of the outer cover (7). The outer cover (7) in the form of a cup has a coolant inlet (8) and a coolant outlet (9).

### CROSS-REFERENCE TO RELATED APPLICATIONS

This application is a U.S. national stage application of International Application No. PCT/EP2006/067139 filed Oct. 6, 2006, which designates the United States of America, and claims priority to German application number 10 2005 052 363.3 filed Nov. 2, 2005, the contents of which are hereby incorporated by reference in their entirety.

### TECHNICAL FIELD

The invention relates to an electric motor and to a use of the electric motor.

### BACKGROUND

Electric motors are known. An electric motor with a multi-pole rotor and a multi-pole stator is described in DE 102 26 976 A1. The electric motor is provided with stator poles encircled by stator windings pointing radially toward the rotor. A rigid insulating sleeve is arranged between the stator and the rotor which extends at least over the length of the rotor, and has projections arranged radially with respect to the rotor, each projection being arranged between two adjacent stator poles. When using electric motors of different design, it is generally disadvantageous that a motor heating occurs during operation, which has to be appropriately dissipated. As a rule, this takes place by means of the ambient air, although in many cases a disadvantageous buildup of heat cannot be avoided.

### SUMMARY

An electric motor with which it is possible to dissipate the accumulating motor heat away from the area of the motor relatively quickly can be created.

According to an embodiment, an electric motor may comprise a rotor, at least two magnet segments, a housing and at least one helical projection, which forms a flow space with a coolant inlet and a coolant outlet, wherein a collar made from plastic and having the at least one helical projection on its outer side is arranged around the housing, and in which a cup-shaped outer cover is arranged around the collar, the at least one helical projection bearing against the inner side of said outer cover, and wherein the cup-shaped outer cover has the coolant inlet and the coolant outlet.

According to a further embodiment, the plastic collar may contain a metal-containing filler. According to a further embodiment, the projection may be chamfered on both sides, the slope angle α with respect to the longitudinal axis being in the range from 50° to 90°. According to a further embodiment, the height H of the projection may be between 1 and 2 mm. According to a further embodiment, a single helical projection may be arranged, which extends from the coolant inlet to the coolant outlet. According to a further embodiment, the cup-shaped outer cover may consist of aluminum and the housing consists of steel. According to a further embodiment, such an electric motor may be used for actuating camshafts in motor vehicles.

### BRIEF DESCRIPTION OF THE DRAWINGS

The invention is explained in more detail and in an exemplary manner below with reference to the drawing (FIG. 1, FIG. 2).

FIG. 1 shows the electric motor without commutator in longitudinal section.

FIG. 2 shows the detail A according to FIG. 1 in an enlarged view.

### DETAILED DESCRIPTION

As stated above, according to an embodiment, an electric motor may have a rotor, at least two magnet segments and a housing in which a collar made from plastic and having at least one helical projection on its outer side is arranged around the housing, and in which a cup-shaped outer cover is arranged around the collar, the at least one helical projection bearing against the inner side of said outer cover, wherein the cup-shaped outer cover has a coolant inlet and a coolant outlet. The plastic collar can be produced, for example, from polyamide. It is drawn onto the housing or injection-molded onto the housing, for example. The plastic can contain carbon fiber components or other fillers. The at least one helical projection can be constructed in different ways with regard to its cross-section. It extends in the longitudinal direction of the motor, whereby it must be ensured that it bears against the inner side of the cup-shaped outer cover and, in doing so, a sealing effect must be achieved. The cup-shaped outer cover has a coolant inlet and a coolant outlet, wherein aqueous solutions, for example, can be used for the coolant. Due to the arrangement of the at least one helical projection, a flow space for the coolant is formed between the collar and the cup-shaped outer cover in the area of the at least one helical projection, it being ensured that the coolant washes virtually uniformly around the plastic collar. Surprisingly, it has been shown that the motor heat can be dissipated relatively quickly from the area of the electric motor when coolant washes around the plastic collar in this way. This completely avoids the disadvantageous buildup of heat as a consequence of the heat dissipation to the ambient air, which only occurs slowly.

A preferred embodiment may consist in that the plastic collar contains a metal-containing filler. This advantageously promotes the heat dissipation, it being possible for copper or silver, for example, to be used as metals. Suitable metal-containing fillers, in addition to metal compounds, are consequently also pure metals which are incorporated into the plastic in the form of lamellae or wafers, for example. Furthermore, it may be particularly advantageously possible to provide the plastic with a glass fiber additive.

According to a further preferred embodiment, the projection may be chamfered on both sides, the slope angle α with respect to the longitudinal axis being in the range from 50° to 90°. This design embodiment of the projection guarantees that it can be used for many kinds of application, and simplifies the production of the electric motor so that serial manufacture can be realized in a relatively easy manner.

A further preferred embodiment provides that the height H of the projection is between 1 and 2 mm. A relatively good flow cross-section is particularly advantageously achieved thereby, while at the same time the required installation space is optimized.

According to a further preferred embodiment, a single helical projection is arranged, which extends from the coolant inlet to the coolant outlet. In doing so, it may be advantageous that the plastic collar can be produced in a simple manner in quantity and, at the same time, a uniform heat dissipation over the longitudinal side of the electric motor is assured.

A further preferred embodiment consists in that the cup-shaped outer cover consists of aluminum and the housing consists of steel. The cup-shaped outer cover can thereby be produced particularly advantageously in quantity in a casting process, while at the same time the housing can act as a magnetic return path ring. Thus, it may be particularly advantageously possible to dispense with the additional arrangement of a magnetic return path ring.

Finally, the electric motor can be used for actuating camshafts in motor vehicles. Previously, the dissipation of motor heat has been problematic, particularly in the case of electric motors, which drive camshafts in motor vehicles. This problem can be solved particularly advantageously by the design of the flow space, wherein, in a particularly advantageous manner, water can be taken from the motor vehicle's cooling circuit as the coolant.

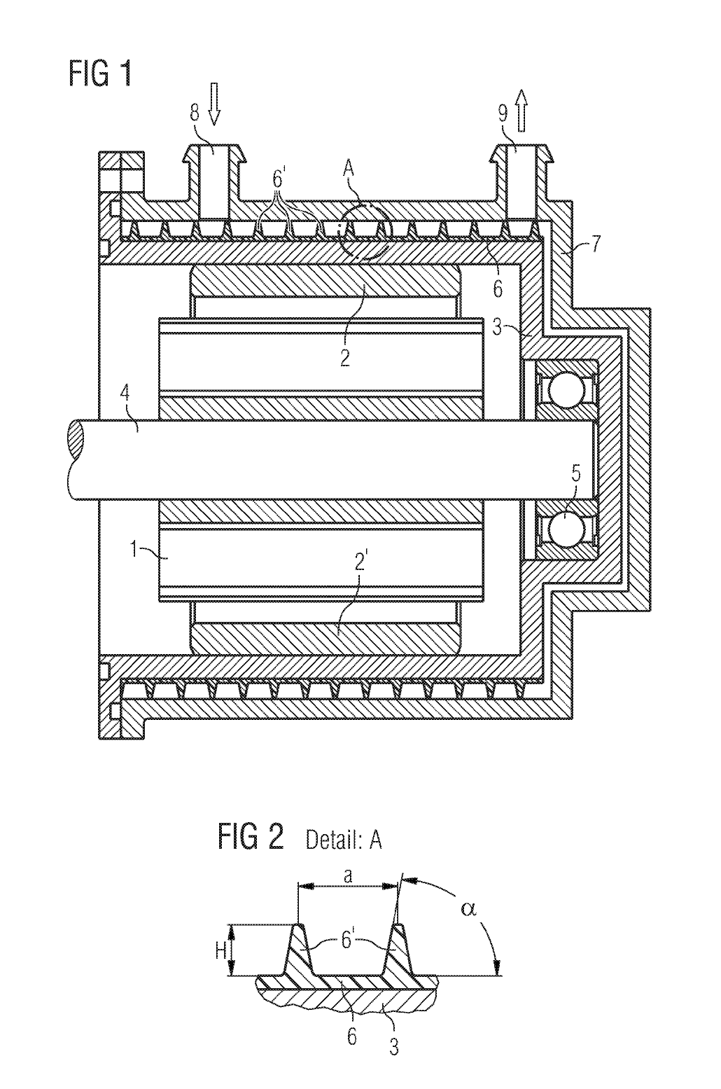

The electric motor without commutator, which has a rotor 1, two magnet segments 2, 2′ and a housing 3 is shown in longitudinal section in FIG. 1. A collar 6 made from plastic and having at least one helical projection 6′ on its outer side is arranged around the housing 3. A cup-shaped outer cover 7 is arranged around the collar 6, the at least one helical projection 6′ bearing against the inner side of said outer cover, wherein the cup-shaped outer cover 7 has a coolant inlet 8 and a coolant outlet 9. Water from the cooling circuit of a motor vehicle, for example, can be used as the coolant if the electric motor is used for actuating camshafts in motor vehicles. The coolant then flows through the coolant inlet 8 and the coolant outlet 9 in the direction of the arrow. In this case, the rotor 1 is mounted rotatably via the shaft 4, a ball bearing 5 acting as the bearing. In this case, a single helical projection 6′, which extends from the coolant inlet 8 to the coolant outlet 9, is arranged as the at least one helical projection 6′. The arrangement of the projection 6′ ensures that virtually the entire outer face of the collar 6 is washed with coolant over the longitudinal direction of the electric motor. In a particularly advantageous embodiment, the cup-shaped outer cover 7 consists of aluminum and the housing 3 consists of steel, which likewise proves to be advantageous for the dissipation of the motor heat. In addition, this is promoted by the incorporation of a metallic filler into the plastic of the collar 6.

The detail A according to FIG. 1 is shown in an enlarged view in FIG. 2. The height H of the projection 6′ is in the range between 1 and 2 mm. This has proven particularly advantageous for many kinds of application. The ratio of the average distance a with respect to the height H is particularly advantageously between 1.9 and 2.2. It is particularly advantageous if the helical projection is chamfered on both sides, the slope angle α with respect to the longitudinal axis being in the range from 50° to 90°. The slope angle α is then regarded in each case as the smallest angle between the longitudinal axis or one of its parallels and the chamfered outer side of the projection. The flow cross-section for the coolant is thereby optimized, which leads to a particularly advantageous dissipation of motor heat.

1. An electric motor comprising a rotor, at least two magnet segments, a housing and at least one helical projection, which forms a flow space with a coolant inlet and a coolant outlet, wherein a collar made from plastic and having the at least one helical projection on its outer side is arranged around the housing, and in which a cup-shaped outer cover is arranged around the collar, the at least one helical projection bearing against the inner side of said outer cover, and wherein the cup-shaped outer cover has the coolant inlet and the coolant outlet.

2. The electric motor according to claim 1, wherein the plastic collar contains a metal-containing filler.

3. The electric motor according to claim 1, wherein the projection is chamfered on both sides, the slope angle α with respect to the longitudinal axis being in the range from 50° to 90°.

4. The electric motor according to claim 1, wherein the height H of the projection is between 1 and 2 mm.

5. The electric motor according to claim 1, wherein a single helical projection is arranged, which extends from the coolant inlet to the coolant outlet.

6. The electric motor according to claim 1, wherein the cup-shaped outer cover consists of aluminum and the housing consists of steel.

7. A method for operating a vehicle, comprising the step of using of an electric motor actuating camshafts in the vehicle wherein the electric motor comprises a rotor, at least two magnet segments, a housing and at least one helical projection, which forms a flow space with a coolant inlet and a coolant outlet, wherein a collar made from plastic and having the at least one helical projection on its outer side is arranged around the housing, and in which a cup-shaped outer cover is arranged around the collar, the at least one helical projection bearing against the inner side of said outer cover, and wherein the cup-shaped outer cover has the coolant inlet and the coolant outlet.

8. The method according to claim 7, wherein the plastic collar contains a metal-containing filler.

9. The method according to claim 7, wherein the projection is chamfered on both sides, the slope angle α with respect to the longitudinal axis being in the range from 50° to 90°.

10. The method according to claim 7, wherein the height H of the projection is between 1 and 2 mm.

11. The method according to claim 7, wherein a single helical projection is arranged, which extends from the coolant inlet to the coolant outlet.

12. The method according to claim 7, wherein the cup-shaped outer cover consists of aluminum and the housing consists of steel.

13. An electric motor comprising
a rotor,
at least two magnet segments,
a housing,
a collar made from plastic and having at least one helical projection on its outer side being arranged around the housing,
a cup-shaped outer cover arranged around the collar, wherein the at least one helical projection is coupled with the inner side of said outer cover, and the cup-shaped outer cover has a coolant inlet and a coolant outlet.

14. The electric motor according to claim 13, wherein the plastic collar contains a metal-containing filler.

15. The electric motor according to claim 13, wherein the projection is chamfered on both sides, the slope angle α with respect to the longitudinal axis being in the range from 50° to 90°.

16. The electric motor according to claim 13, wherein the height H of the projection is between 1 and 2 mm.

17. The electric motor according to claim 13, wherein a single helical projection is arranged, which extends from the coolant inlet to the coolant outlet.

18. The electric motor according to claim 13, wherein the cup-shaped outer cover consists of aluminum and the housing consists of steel.
